(19) United States
(12) Patent Application Publication
(10) Pub. No.: US 2026/0010799 A1
(43) Pub. Date: Jan. 8, 2026

(54) LEGO: LANGUAGE MODEL BUILDING BLOCKS

(71) Applicant: Georgia Tech Research Corporation, Atlanta, GA (US)

(72) Inventors: Shrenik Bhansali, Atlanta, GA (US); Larry Heck, Atlanta, GA (US); Alwin Jin, Atlanta, GA (US); Tyler Lizzo, Atlanta, GA (US)

(21) Appl. No.: 19/263,168

(22) Filed: Jul. 8, 2025

Related U.S. Application Data
(60) Provisional application No. 63/668,592, filed on Jul. 8, 2024.

(51) Int. Cl. G06N 3/096; G06N 3/082

(52) U.S. Cl. CPC G06N 3/096; G06N 3/082

(57) ABSTRACT

The present disclosure provides a method for federated fine-tuning of language models. The method comprises pruning a large language model (LLM) to create multiple small language models (SLMs) with different sparsity levels, assigning each SLM to a client device, fine-tuning each SLM on local data of its assigned client device, aggregating the fine-tuned SLMs to create a global update, and applying the global update to the SLMs and a global LLM. The method enables efficient fine-tuning and inference while preserving privacy and optimizing performance across varied resource constraints.

### CROSS-REFERENCE TO RELATED APPLICATIONS

This application claims priority to U.S. Prov. Pat. Appl. No. 63/668,592, filed Jul. 8, 2024, which is hereby incorporated by reference in its entirety.

### FIELD OF INVENTION

The present disclosure relates to language model optimization techniques, and more particularly to a federated learning system for efficiently fine-tuning and aggregating pruned language models of heterogeneous sizes.

### BACKGROUND

Large language models (LLMs) have become increasingly prevalent in natural language processing applications due to their ability to generalize across a wide range of tasks. These models are typically trained on vast amounts of data and fine-tuned for specific downstream applications. However, the development and deployment of LLMs face several challenges.

One challenge is the substantial computational resources required for training, fine-tuning, and inference with LLMs. The large size of these models leads to high costs in terms of processing power, memory usage, and energy consumption. This can limit their practical implementation, especially on resource-constrained devices or in scenarios where rapid inference is needed.

Another consideration is data privacy. Fine-tuning LLMs often involves collecting and utilizing large amounts of user data, which may contain sensitive or personal information. There are growing concerns about protecting user privacy while still leveraging data to improve model performance.

Additionally, while LLMs excel at generalization, they may not always be the optimal solution for every use case. Smaller, task-specific models can sometimes outperform larger models on particular applications. However, these smaller models often lack the robustness and broad capabilities of their larger counterparts.

Federated learning has emerged as an approach to address some of these challenges. This technique allows for distributed training of models across multiple devices or servers without centralizing the training data. However, federated learning with large language models introduces its own set of complexities, including communication overhead and potential inconsistencies between local and global models.

Furthermore, the heterogeneity of client devices in real-world federated learning scenarios presents additional hurdles. Devices may have varying computational capabilities, storage capacities, and network conditions. This diversity complicates the process of deploying and updating models across a federated system.

As natural language processing applications continue to evolve and expand, there is an ongoing need for techniques that can balance the trade-offs between model size, performance, privacy, and resource utilization. Addressing those challenges could enable more widespread and efficient deployment of language models across a diverse range of devices and use cases.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for federated fine-tuning of language models is provided. The method includes pruning a large language model (LLM) to create multiple small language models (SLMs) with different sparsity levels, assigning each SLM to a client device, fine-tuning each SLM on local data of its assigned client device, aggregating the fine-tuned SLMs to create a global update, and applying the global update to the SLMs and a global LLM.

According to other aspects of the present disclosure, the method may include one or more of the following features. The pruning may be performed using an activation-based pruning technique. The SLMs may have different model architectures. The fine-tuning may be performed using Low-Rank Adaptation (LoRA). The aggregating may include creating a mask for each SLM's LoRA adapter based on its sparsity level and aggregating the masked adapters with the global LLM's LoRA adapter. The method may further include evaluating performance of the SLMs and global LLM using a benchmark dataset.

According to another aspect of the present disclosure, a system for federated fine-tuning of language models is provided. The system includes a server configured to prune a large language model (LLM) to create multiple small language models (SLMs) with different sparsity levels, and multiple client devices, each assigned an SLM, configured to fine-tune their assigned SLM on local data. The server is further configured to aggregate the fine-tuned SLMs to create a global update and apply the global update to the SLMs and a global LLM.

According to other aspects of the present disclosure, the system may include one or more of the following features. The server may be configured to perform the pruning using an activation-based pruning technique. The SLMs may have different model architectures. The client devices may be configured to perform the fine-tuning using Low-Rank Adaptation (LoRA). The server may be configured to perform the aggregating by creating a mask for each SLM's LoRA adapter based on its sparsity level and aggregating the masked adapters with the global LLM's LoRA adapter. The server may be further configured to evaluate performance of the SLMs and global LLM using a benchmark dataset.

According to yet another aspect of the present disclosure, a non-transitory computer-readable medium storing instructions is provided. The instructions, when executed by a processor, cause the processor to perform operations including pruning a large language model (LLM) to create multiple small language models (SLMs) with different sparsity levels, assigning each SLM to a client device, fine-tuning each SLM on local data of its assigned client device, aggregating the fine-tuned SLMs to create a global update, and applying the global update to the SLMs and a global LLM.

According to other aspects of the present disclosure, the operations may include one or more of the following features. The pruning may be performed using an activation-based pruning technique. The SLMs may have different model architectures. The fine-tuning may be performed using Low-Rank Adaptation (LoRA). The aggregating may include creating a mask for each SLM's LoRA adapter based on its sparsity level and aggregating the masked adapters with the global LLM's LoRA adapter. The operations may further include evaluating performance of the SLMs and global LLM using a benchmark dataset.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a computing system, according to aspects of the present disclosure.

FIG. 2 depicts a block diagram of a client device, in accordance with example embodiments.

FIG. 3 shows a federated learning workflow for language model optimization, according to an embodiment.

FIG. 4 illustrates an aggregation system for combining adapter matrices, according to aspects of the present disclosure.

FIGS. 5-6 depict sequence diagrams showing block combination and aggregation, in accordance with example embodiments.

FIG. 7 shows a graph of performance accuracy versus number of client models aggregated, according to an aspect of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Federated learning (FL) is a distributed training methodology that trains a model across multiple decentralized devices while allowing data to remain on the user machines. In conventional FL, each client device has its own native model and trains it on user inputs. Instead of sharing this client data globally, the models instead share their own model weights, aggregating them with other client weights. This creates a global update that encodes the knowledge gained from all model updates without compromising data privacy.

Federated learning addresses several key challenges in machine learning, particularly for large language models. By keeping data localized, it enhances privacy protection, as sensitive user information never leaves the client devices. This approach also reduces the need for massive, centralized data storage and processing infrastructure.

The federated learning process typically involves several steps. First, the server initializes a global model and distributes it to participating client devices. Each client then trains the model on its local data, computing updates to the model parameters. These local updates, rather than the raw data, are sent back to the server. The server aggregates the updates from all clients, often using techniques like federated averaging, to create a new global model. This updated global model is then redistributed to the clients, and the process repeats in multiple rounds.

This methodology is particularly beneficial for scenarios where data cannot be centralized due to privacy concerns, regulatory requirements, or practical limitations. For example, in mobile applications, federated learning allows for personalization of models without compromising user privacy. In healthcare, it enables collaboration between institutions without sharing sensitive patient data.

However, federated learning also presents unique challenges. These include dealing with non-independent and identically distributed (non-IID) data across clients, managing communication efficiency, and ensuring the security and integrity of the learning process. Researchers continue to develop techniques to address these challenges, such as adaptive aggregation methods, efficient compression of model updates, and secure aggregation protocols.

This same methodology may be applied to fine-tuning for LLMs. Instead of training a client model on user data, client models may be fine-tuned on user instructions. This approach may ease many of the barriers to data collection compared to traditional centralized fine-tuning, as users may retain privacy over their instructions while contributing to the model.

This methodology of federated learning can be effectively applied to the process of fine-tuning Large Language Models (LLMs). In this context, instead of training client models on raw user data, which may contain sensitive information, the models are fine-tuned using user instructions. These instructions are typically less sensitive and more focused on the specific tasks or queries that users want the model to perform.

By utilizing user instructions for fine-tuning, this approach addresses several key challenges in traditional centralized fine-tuning methods. Firstly, it significantly reduces privacy concerns, as users can contribute to model improvement without sharing their personal data. The instructions provided are generally less likely to contain sensitive information compared to raw user data.

Secondly, this method can potentially increase the diversity and quality of training data. Users from various backgrounds and with different needs can contribute their unique instructions, leading to a more versatile and robust model. This diversity can be particularly valuable in capturing nuanced language use and task-specific requirements across different domains.

Furthermore, this approach may encourage greater user participation in the model improvement process. Users may be more willing to contribute instructions when they know their personal data remains private, potentially leading to a larger and more engaged user base for model fine-tuning.

However, it's important to note that while this method enhances privacy, it may still face challenges in ensuring the quality and relevance of user-provided instructions. Additionally, mechanisms may need to be implemented to filter out potentially harmful or biased instructions to maintain the integrity and fairness of the resulting model.

Two fundamental assumptions may be made in both traditional FL and FL for fine-tuning. The first is that all data is i.i.d, meaning that not only do all clients have similar amounts of data, but that the ratio of content within each are similar. The study of non-i.i.d data distributions in FL is often referred to as heterogeneous FL, with many strategies and techniques being proposed to offset the effects of data heterogeneity.

The second assumption is that all model architectures in FL systems are identical, allowing

for the aggregation of model weights when creating global updates. As such, there is much less literature on model heterogeneity in FL than data heterogeneity. Model architecture heterogeneity presents unique challenges in FL. Differing client model architectures impede the use of standard aggregation techniques like FedAvg due to varying parameter sizes.

Much like data-heterogeneous FL, many strategies have been proposed to offset the effect of model heterogeneity, allowing for model-agnostic FL. Previous work surrounding model-agnostic FL points towards using a proxy unlabeled public dataset to unify trained weights between different models. This approach allows the construction of a cross-correlation matrix to learn a generalizable representation under domain shift. However, due to the generality of LLMs, finding and using a large and diverse enough dataset to unify models distilled for diverse specific downstream tasks is impractical.

In some embodiments of the disclosed technology, a model-agnostic FL system is provided for language model building blocks. Like stacking small building blocks together to create a larger structure, the disclosed provides stacking of small language models (SLMs) together to create a larger, more robust large language model (LLM).

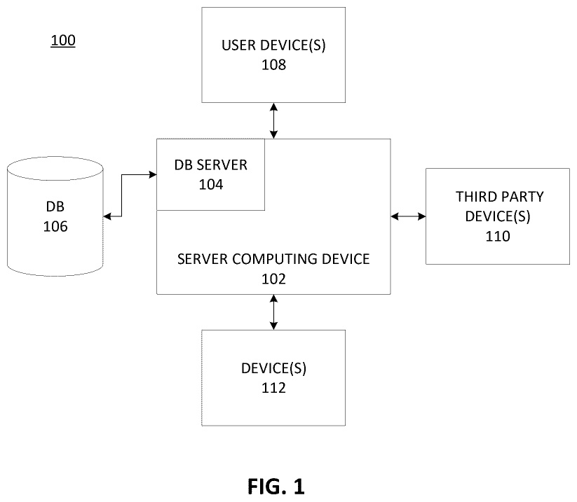

FIG. 1 illustrates a computing system 100. The computing system 100 may include a server computing device 102, a database server 104, a database 106, user devices 108, third party devices 110, and peripheral devices 112.

The server computing device 102 may be connected to and communicate with the other components of the computing system 100. In some cases, the server computing device 102 may manage and coordinate operations between the various components.

A database server 104 may be included within or connected to the server computing device 102. The database server 104 may interface with a database 106, facilitating data storage and retrieval operations for the computing system 100.

The computing system 100 may include user devices 108 that connect to the server computing device 102. These user devices 108 may allow users to interact with the computing system 100. In some cases, the user devices 108 may include resource-constrained devices such as IoT devices or smartphones.

Third party devices 110 may also be connected to the server computing device 102. These third party devices 110 may enable integration with external systems or services, expanding the capabilities of the computing system 100.

Peripheral devices 112 may be connected to the server computing device 102. These peripheral devices 112 may provide additional functionality or support to the computing system 100.

The components of the computing system 100 may communicate with each other through various communication pathways. For example, the server computing device 102 may exchange data and instructions with the user devices 108, third party devices 110, and peripheral devices 112. The database server 104 may manage communications between the server computing device 102 and the database 106, handling data operations and storage requests.

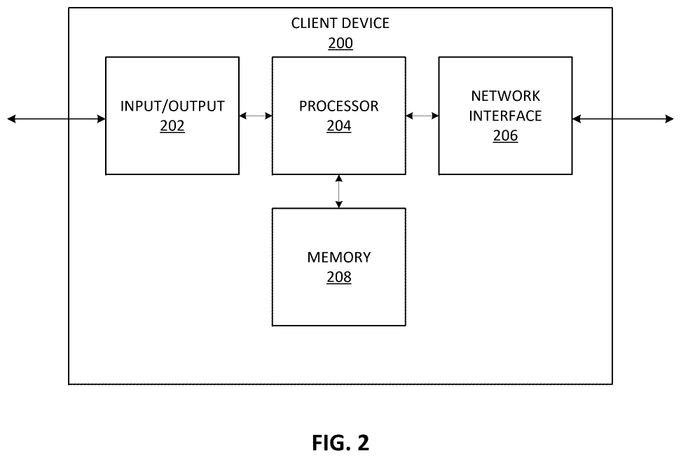

FIG. 2 illustrates a block diagram of a client device 200. The client device 200 may be one of the user devices 108 that connects to the server computing device 102 within the computing system 100.

A client device 200 may include an input output interface 202, a processor 204, a network interface 206, and memory 208. These components may work together to enable the client device 200 to interact with the computing system 100 and perform various functions.

An input output interface 202 may be connected to the processor 204. The input output interface 202 may allow for data input and output operations with the client device 200. In some cases, the input output interface 202 may include hardware components such as displays, keyboards, touchscreens, or other input/output peripherals.

A processor 204 may be connected to the input output interface 202, the network interface 206, and the memory 208. The processor 204 may coordinate operations between these components to enable processing and management of data within the client device 200. In some cases, the processor 204 may execute instructions stored in the memory 208 to perform various tasks or run applications.

A network interface 206 may be connected to the processor 204. The network interface 206 may enable communication between the client device 200 and external networks or devices. In some cases, the network interface 206 may allow the client device 200 to connect to the server computing device 102 or other components of the computing system 100.

Memory 208 may be connected to the processor 204. The memory 208 may provide storage capabilities for the client device 200. In some cases, the memory 208 may store data, applications, or instructions that can be accessed and executed by the processor 204.

The components of the client device 200 may work together to enable various functionalities. For example, data received through the network interface 206 may be processed by the processor 204 and stored in the memory 208. The processor 204 may then retrieve this data from the memory 208, process it further, and output results through the input output interface 202.

In some cases, the client device 200 may be a resource-constrained device with limited processing power or memory capacity. The structure and components of the client device 200 may be designed to operate efficiently within these constraints while still enabling interaction with the computing system 100.

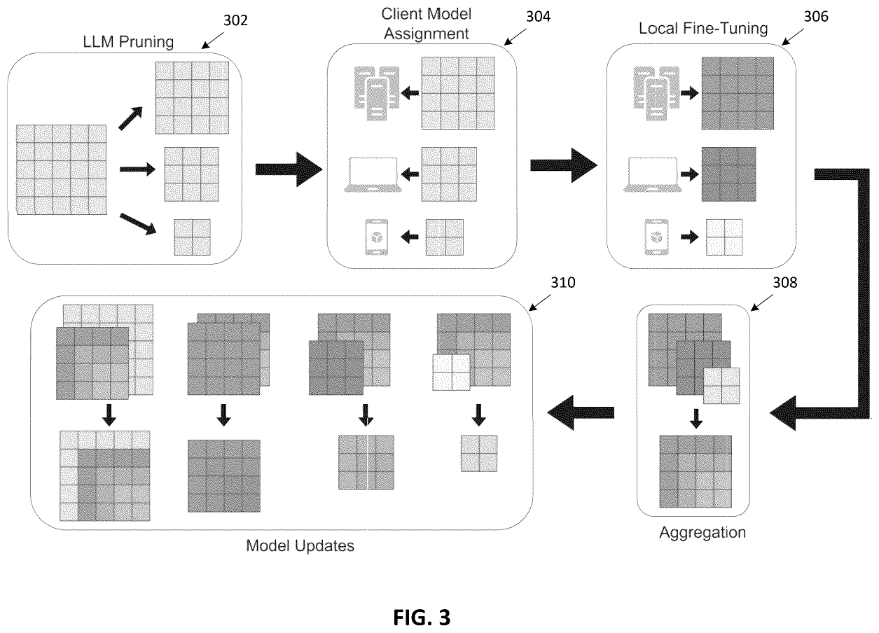

In some embodiments of the disclosed technology, a two-step approach may be used. First, SLMs of different sizes may be obtained by pruning an LLM. Second, the SLMs may be deployed in a FL environment, eventually aggregating them into an LLM. FIG. 3 illustrates an exemplary workflow 300 of this two-step approach. Referring to FIG. 3, in 302, an LLM is pruned to create SLMs. In 304, each SLM is assigned to a client. In 306, each client fine-tunes its SLM on its local data.

In 308, the models are aggregated to create a global update. In 310, the global update is applied to all the client SLMs as well as a global LLM. Eventually, after enough updates, a final global LLM is derived.

The two-step approach described above forms the core of the disclosed technology's federated learning methodology for language model optimization. In the first step, the process begins with a large language model (LLM) that is pruned to create multiple small language models (SLMs) of varying sizes. This pruning process involves selectively removing parameters or connections within the LLM while aiming to preserve its overall performance. The resulting SLMs have different levels of sparsity, which allows for more efficient computation and storage on resource-constrained devices.

The second step involves deploying these SLMs in a federated learning (FL) environment. This distributed approach allows for the training and fine-tuning of models across multiple decentralized devices while maintaining data privacy. Each SLM is assigned to a client device, which could be a user device 108 within the computing system 100 as described earlier. These client devices may have varying computational capabilities, making the use of differently sized SLMs particularly advantageous.

Once assigned, each client fine-tunes its SLM using local data available on the device. This localized fine-tuning process allows the SLMs to adapt to specific tasks or domains relevant to each client, potentially improving performance on user-specific applications. The fine-tuning process may utilize techniques such as Low-Rank Adaptation (LoRA) to efficiently update the model parameters.

After the fine-tuning phase, the updated SLMs from multiple clients are aggregated to create a global update. This aggregation process combines the knowledge learned by individual SLMs across different devices and tasks. The global update is then applied not only to all the client SLMs but also to a global LLM maintained by the server computing device 102. This step ensures that the improvements made by individual clients contribute to the overall performance of the system.

The process of fine-tuning, aggregation, and global update application may be repeated over multiple rounds. With each iteration, the global LLM incorporates more diverse knowledge from the distributed SLMs, potentially becoming more robust and generalizable. Eventually, after a sufficient number of update cycles, a final global LLM is derived that benefits from the collective learning across all participating client devices.

This approach offers several advantages. It allows for efficient model optimization on devices with limited resources, preserves user privacy by keeping raw data on client devices, and enables the creation of a powerful global model that leverages distributed learning. The method also provides flexibility in handling heterogeneous client devices and diverse task requirements within a single federated learning framework.

FIG. 3 illustrates a federated learning workflow for language model optimization. The workflow may include a model pruning step 300, an LLM pruning step 302, a client model assignment step 304, a local fine tuning step 306, an aggregation step 308, and a model update step 310.

A model pruning step 300 may be performed to reduce the size and complexity of a large language model (LLM). This step may involve selectively removing parameters or connections within the model while aiming to preserve its overall performance.

An LLM pruning step 302 may be carried out as part of the model pruning step 300. During the LLM pruning step 302, specific techniques may be applied to prune the LLM, potentially creating smaller language models (SLMs) with varying levels of sparsity.

A client model assignment step 304 may follow the LLM pruning step 302. In this step, SLMs with different sparsity levels may be assigned to different client devices. For example, SLMs with sparsity levels of 0%, 25%, 50%, and 75% may be distributed among the user devices 108 within the computing system 100. The assignment may be based on factors such as the computational resources available on each client device 200.

A local fine tuning step 306 may be performed on the client devices 200 after the client model assignment step 304. During this step, each assigned SLM may be fine-tuned using task-specific data available on the respective client device 200. That process may create specialized SLMs tailored to different tasks or domains.

An aggregation step 308 may be carried out after the local fine tuning step 306. In this step, the server computing device 102 may collect and combine the fine-tuned SLMs from multiple client devices 200. The aggregation process may involve merging the learned parameters or weights from different SLMs.

A model update step 310 may be performed following the aggregation step 308. During this step, the combined knowledge from the aggregated SLMs may be used to update a global language model. That updated model may incorporate the diverse task-specific knowledge learned across multiple client devices 200 while maintaining the overall structure and capabilities of the original LLM.

In some cases, the federated learning workflow may be iterative, with multiple rounds of client model assignment, local fine tuning, aggregation, and model updates. This iterative process may allow for continuous improvement and adaptation of the language models while preserving privacy and enabling distributed learning across the computing system 100.

The SLMs produced by the pruning process are the local client models in the FL environment. SLMs of different sizes and model architectures may be produced to better match the various computational budgets of client devices. A full-sized LLM may be used as the global model, meaning that every client model is a sub-network of the global model.

A federated fine-tuning process may be used to produce a fine-tuned LLM using the client SLMs. Selected client SLMs for each round may be fine-tuned on their respective client's local data. Next, they are aggregated with each other, creating a global update. The global update may then be applied to all client SLMs and the global LLM. That process may be repeated for every round of FL, eventually forming a robust, fine-tuned LLM built up from the updates supplied by the fine-tuned client SLMs.

The federated fine-tuning process may include the following conditions: i) all fine-tuning may be done using Low-Rank Adaptation (LoRA), resulting in a more computationally efficient fine tuning process; ii) all aggregation occurs over LoRA adapters, allowing for decreased communication cost and more efficient aggregation; and iii) all fine-tuning may be done using a large dataset or a subset thereof (e.g., databricks-dolly-15k dataset generated by Databricks covering eight different capability domains).

In one exemplary embodiment, an FL system may be simulated for illustration of the disclosed technology. In this example, four model sparsity levels may be examined (e.g., 0%, 25%, 50%, and 75%), where each percentage indicates the proportion of weights that have been removed. To create SLMs, SparseGPT may be used to remove the weights from an LLM (e.g., LLaMA-7B LLM) and generate the specified level of sparsity in each model.

If SLMs are the building blocks, then FL is the process of assembling the blocks into a structure and the resulting LLM is the final structure built from those blocks. A model-agnostic FL environment may be created to allow aggregation between different sized SLMs and the global LLM. At the end of the FL process, a fine-tuned global LLM may be obtained, constructed through the aggregation of SLMs. Selected SLMs may be representative of client devices in the illustrative example. That building block approach enables efficient knowledge sharing across heterogeneous devices while maintaining the privacy benefits of federated learning. The SLMs can be tailored to the computational constraints of individual client devices, while still contributing valuable updates to the global model. That modular architecture allows for flexible deployment across a wide range of hardware configurations, from resource-constrained IoT devices to more powerful edge computing platforms.

Algorithm 1 details the disclosed FL system, where clients would be assigned their respective SLMs with wn sparsity, representing the sparsity present in both the model and the LoRA adapter. The clients may be selected for fine-tuning through a client selection process. During the training loop, clients fine-tune their LoRA adapters on local data created from a subset of the training dataset. After fine-tuning, each of the selected clients may have their LoRA adapters aggregated with each other to form a global update through a heterogeneous model aggregation (HeteAgg) scheme. That global update may then be applied to each of the client SLMs in addition to the global LLM. After the training loop is complete, final adapters and global updates may be derived.

Algorithm 1 Federated Fine-Tuning with Heterogeneous Models

```
Initialization:
Each client [symbol] initializes LLM with parameter sparsity [symbol]
M ← [symbol] K communication rounds; k ← 0.
Training Loop:
while k ≤ K do
  Update M to select clients based on sparsity [symbol]
  for each client n ∈ M do
    Select model for [symbol] with [symbol]
    Δ [symbol] ← Instruction Tune(Δ [symbol] ).
  end for
  Δ [symbol] ← HeteAgg({Δ [symbol] ∈ M}).
  k ← k + 1.
end while
Outcome:
Derive final adapters Δ [symbol] update global LLM [symbol] [symbol]
indicates data missing or illegible when filed
```

The HeteAgg in Algorithm 2 enables an FL paradigm. First, a global LLM may be instantiated to hold the eventual global update. The global update may be formed by aggregating the client SLMs. Aggregation may be done by accessing each of the selected client's LoRA adapters and creating a mask for it based on its sparsity. The sparse mask may then be aggregated with the global LLM's LoRA adapter wherever there is an overlap between the mask and the adapter. Since sparsity is represented by a parameter magnitude “0” in the SLM's LoRA adapters, this process effectively averages the nonzero parameters between the client and global models.

Algorithm 2 Model Heterogeneous Aggregation (HeteAgg)

```
Define global model g initialized to a baseline state.
for each client in selected clients set do
  Load client model state dictionary: [symbol]
  Identify [symbol] the set of common parameters be-
tween [symbol] and g
  Initialize [symbol] ← [symbol]
  for each parameter p ∈ [symbol] do
    Load [symbol] from [symbol] and [symbol] from g
    Define masks Mₛ ← [symbol] [symbol]
    ← [symbol] \hat{ } [symbol] [symbol]
    ← where( [symbol] ( [symbol] + [symbol] ) [symbol]
where( [symbol] )) [symbol]
    ← [symbol]
  end for
  Update g with [symbol]
end for [symbol]
indicates data missing or illegible when filed
```

By only aggregating across the nonzero weights, sparsity may be retained in the client model's adapter without halving the global adapter's weights when there is no corresponding nonzero value. This process of mask creation and aggregation occurs for every client in the selected client group, forming a global update through the global LLM's adapter. Since every client SLM is a sub-model of the LLM, the global update may be applied to each client in the same manner again using HeteAgg, averaging across each client's nonzero weights.

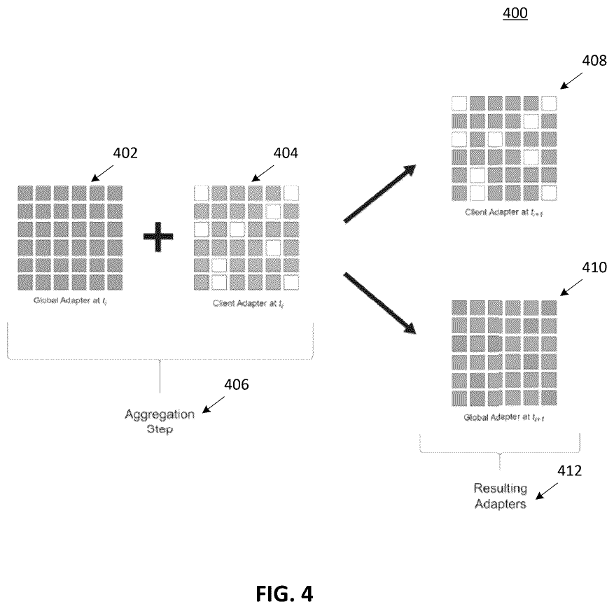

FIG. 4 illustrates an aggregation process 400 for combining adapter matrices. The aggregation process 400 may include a global adapter matrix 402, a client adapter matrix 404, an aggregation step 406, a client adapter output 408, a global adapter output 410, and resulting adapters 412.

A global adapter matrix 402 may represent parameters or weights associated with a large language model (LLM) maintained by the server computing device 102. In some cases, the global adapter matrix 402 may contain information learned across multiple tasks or domains.

A client adapter matrix 404 may represent parameters or weights associated with a small language model (SLM) that has been fine-tuned on a specific task or domain by a client device 200. The client adapter matrix 404 may contain specialized knowledge learned during the local fine-tuning step 306.

An aggregation step 406 may be performed to combine the global adapter matrix 402 and the client adapter matrix 404. The aggregation step 406 may utilize a heterogeneous model aggregation scheme called HeteAgg. This scheme may allow for the aggregation of SLMs with different sizes or sparsity levels.

In some cases, the aggregation step 406 may operate on LoRA (Low-Rank Adaptation) adapters instead of full model weights. This approach may reduce communication costs between the client device 200 and the server computing device 102 during the aggregation process.

The aggregation step 406 may produce two distinct outputs: a client adapter output 408 and a global adapter output 410. The client adapter output 408 may represent an updated version of the client adapter matrix 404 that incorporates knowledge from the global adapter matrix 402. The global adapter output 410 may represent an updated version of the global adapter matrix 402 that incorporates task-specific knowledge from the client adapter matrix 404.

Resulting adapters 412 may be generated based on the client adapter output 408 and the global adapter output 410. These resulting adapters 412 may contain a combination of generalized knowledge from the LLM and specialized knowledge from the task-specific SLM.

The aggregation process 400 may enable the creation of a generalized LLM by combining multiple task-specific SLMs. That process may allow the computing system 100 to leverage distributed learning across multiple client devices 200 while maintaining the overall structure and capabilities of the original LLM.

The global adapter matrix 402 may by a global LoRA adapter and the client adapter matrix 404 may be a sparsified client LoRA adapter. The aggregation step (left-hand side) 406 displays each adapter at time step ti, before aggregation. During aggregation, the blue and red parameters average to create purple parameters for non-zero red (client) parameters. For zero-valued red (client) parameters, the updated client model retains its sparsity, as shown in client adapter output 408, whereas the updated global LoRA adapter uses the blue (global) parameter values, as shown in the global adapter output 410. As a result, the updated global adapter is a 0% sparsity adapter. Thus, the resulting adapters (right-hand side) 412 displays each adapter at time step ti+1, where the parameters are aggregated only when there is an overlap between the corresponding non-zero parameters of each model.

The efficacy of the disclosed technology and methods may be evaluated through various experimental approaches designed to address key questions about the system's performance and capabilities.

In one example test scenario, the disclosed technology and the methods described herein may be compared with two baselines: i) a FedIT-produced global model resulting from 4 LLaMA-7B models fine-tuned over iid data. This baseline is the idea case to FedIT; and ii) a FedIT-produced global model resulting from 8 task-specific LLaMA-7B models where each model is only fine-tuned on one of the 8 different domain areas of databricks-dolly-15k.

FedIT is a foundational FL framework that the disclosed methods and algorithms extends. In the example, LLaMA-7B model with LoRA adapters may be used. Each adapter may be sequentially fine-tuned and then aggregated using FedAvg into the global model.

Since the computational cost of HeteAgg is the same as FedAvg, all speedups in the disclosed may be a direct result of model pruning. During the example experiments, a 1.7× speedup in inference and up to a 1.4× speedup in fine-tuning using SparseGPT-produced SLMs when compared to 0% sparsity LLMs.

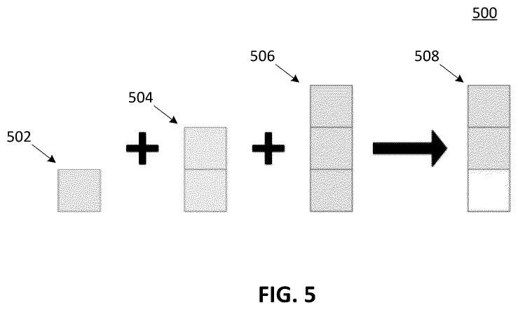

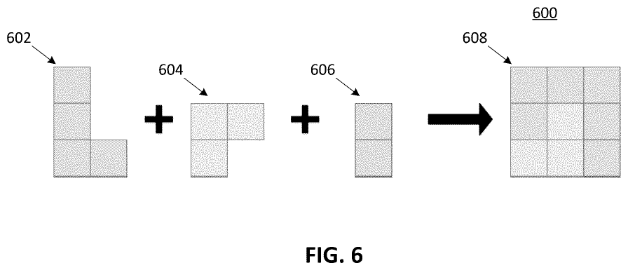

FIGS. 5-6 illustrate block combination and aggregation processes that may be used in the computing system 100. These processes may demonstrate how different components or models can be combined to create more complex structures or aggregated models.

A first sequence diagram 500 may show the combination of three distinct blocks. A first block 502 may be represented as a small green square. A second block 504 may be depicted as a blue rectangular shape. A third block 506 may be shown as a red rectangular shape. These blocks may represent different components or models within the computing system 100.

In some cases, the first block 502, the second block 504, and the third block 506 may be combined using addition operators. This combination process may result in a combined block 508. The combined block 508 may incorporate elements from all three source blocks, creating a layered composition. The combined block 508 may display a red portion at the top, followed by purple and white sections.

When using building blocks, blocks of varying sizes may be encountered often. To create a cohesive structure, differently sized blocks may be stacked on top of one another. This concept is central the disclosed methodology, as much like the blocks, differently sized SLMs must be assembled together to create a robust LLM. FIG. 5 depicts an example representation 500 of how three different SLMs 502, 504, 506, may be stacked, or aggregated together to produce structure 508. Each color is representative of the SLM's knowledge. When being stacked, similar to FIG. 4, it can be seen that wherever there is an overlap, the average is taken between the overlapping blocks. The final, resultant block 508 consists of three sections: i) the top red layer, where the largest block does not overlap with others; ii) the middle purple layer, an average of the blue and red where two blocks overlap; and iii) the bottom white section, where all three blocks overlap.

This averaging of colors is representative of the knowledge being transferred between the models.

In some embodiments, successful stacking of heterogeneous SLMs would be each SLM learning from each other, with knowledge transferring between models. Thus, this example experiment tests the effectiveness of HeteAgg, the disclosed “stacking” mechanism, by creating an FL environment with exclusively heterogeneous clients. The example scenario is set up with four clients, each with a different sparsity level (e.g., 0%, 25%, 50%, and 75%). Each client has an iid portion of localized data to fine-tune over.

Table 1 displays the performance of the different-sized models at three stages for a model composition with 4 strictly heterogeneous models. The first is when they were initially pruned before fine-tuning (Pruned), the second is after they were fine-tuned on their local data (Fine-Tuned), and the last is the final adapters after all FL rounds and global updates were complete (Aggregated). As shown in the table, fine-tuning improves performance for all model sizes, with a significant performance gain at the 75% sparsity level. The aggregation stage improves performance for all model sizes at 0%-50% sparsity but degrades at 75% sparsity.

TABLE 1
Performance Metrics on HellaSwag

| | Sparsity | | Fine- | |
|---|---|---|---|---|
| Composition | Level | Pruned | Tuned | Aggregated |
| 4 Strictly | 0% | 0.5694 | 0.5760 | 0.5836 |
| Heterogeneous | 25% | 0.5654 | 0.5784 | 0.5801 |
| Models | 50% | 0.5144 | 0.5244 | 0.5411 |
| | 75% | 0.2989 | 0.3631 | 0.3167 |
| 5 SLMs With iid | 0% | 0.5694 | — | 0.5811 |
| Data Distribution | 50% | 0.5144 | — | 0.5404 |
| 8 Task-Specific | 0% | 0.5694 | — | 0.5858 |
| SLMs | 75% | 0.2989 | — | 0.3638 |
| FedIT: 4 LLMs With iid | 0% | 0.5694 | — | TODO |
| Data Distribution | | | | |
| FedIT: 8 Task- | 0% | 0.5694 | — | TODO |
| Specific LLMs | | | | |

Comparing against the FedIT-produced baseline with 4 strictly homogeneous LLMs, when using heterogeneous models, equally robust 0% LLM is produced. Additionally, the 25% sparsity model is equally robust, while at 50% sparsity, performance begins to decrease.

The degraded performance 75% sparsity model is due to the SLM's limited size. Previous work has shown that smaller models can be better learners for specific tasks, resulting in more strongly tuned weights to offset size constraints. During aggregation with larger models, the stronger learned representation in smaller models may be diluted by the larger model's weaker representation, causing the smaller model's performance to degrade.

The 0% sparsity LLM after aggregation is robust and comparable to the example baselines. Those results show that the disclosed methodology accounts for clients who have diverged from their learned representations due to high sparsity or overfitting client data.

When building large structures, it is common to assemble smaller sub-units individually and then combine them to yield the final structure. Similarly, as the disclosed, smaller models may be fine-tuned individually like sub-units, and then aggregated together at the end to produce a final LLM.

The disclosed technology may be tested to have the same capability by exclusively composing SLMs and aggregating them together to create a robust LLM. That example tests the transferability of knowledge from SLMs to an LLM using the methods disclosed herein. In that example, five 50% sparsity client SLMs are employed for fine-tuning and aggregating and applying the resulting global updates to a 0% sparsity global LLM.

The results of that example, composed with 5 SLMs with iid data distribution, are in Table 1. Despite only fine-tuning SLMs, a 0% LLM is achieved better than the FedIT LLM produced from 4 LLMs with an iid data distribution. Those results demonstrate that the methods described herein allow for knowledge transfer from strictly smaller models to a larger model in an effective manner.

Just as not all building blocks are the same size, they may not necessarily be the same shape. Regardless of the size or shape, the requirement is that they can stack together. The methods described herein demonstrates this principle.

A second sequence diagram 600 may illustrate the aggregation of differently shaped blocks. An L-shaped block 602 may be shown in purple. A T-shaped block 604 may be depicted in blue. A rectangular block 606 may be presented in red. These blocks may represent various components or models with different structures or characteristics within the computing system 100.

The L-shaped block 602, the T-shaped block 604, and the rectangular block 606 may be combined using addition operators. This aggregation process may result in an aggregated block 608. The aggregated block 608 may form a complete square shape, integrating the different colored sections from the original blocks. The aggregated block 608 may demonstrate how disparate shapes can be assembled into a cohesive unified form while maintaining the distinct characteristics of the component blocks.

The example experiment of this section evaluates knowledge transfer in a non-iid data distribution scenario. Using eight 75% sparsity client SLMs; each fine-tuned on one of the eight capability domains in the databricks-dolly-15k dataset. The resulting global updates from the client aggregation stages are then applied to a global LLM.

The results of this example are in Table 1. Despite each model being fine-tuned on a different task, the knowledge transfers between models result in a more robust global LLM than any of the previous experiments. This may be attributed to the small size of the SLMs. As discussed prior, previous work in KD has shown that smaller models are more adept learners when it comes to task specific models. No previous study has explored task-specific SLMs in the context of pruning. However, the results demonstrate that the same task-specific adaptation strength present in KS produced SLMs is also present in pruning-produced SLMs, despite not distilling over select tasks.

The learned representations in the SLMs are more strongly reflective of their fine-tuning data due to their limited size. Thus, when aggregating the SLMs with the global LLM, the LLM obtains the stronger task specific representations from the SLMs, while being bolstered by its larger size, thus translating to a more robust model. Thus, the results demonstrate that smaller models make better task-specific learners, and their knowledge can be effectively transferred to larger models, yielding robust LLMs while only fine-tuning SLMs.

When compared against the FedIT baseline with 8 task-specific LLMs, the disclosed methodology produces an LLM that outperforms the FedIT produced LLM, despite only using models a quarter of the size.

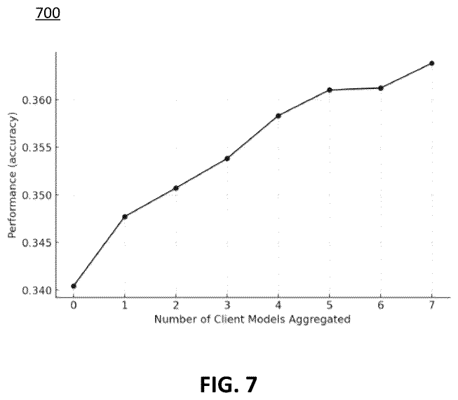

Additionally, an example test shows how well knowledge transfers between the SLMs. To do so, the performance of client SLMs may be tracked over time, evaluating their performance after every global update. FIG. 7 depicts a plot 700 demonstrating that after every communication round, the performance of the client SLMs increase. Thus, it may be determined that if one model learns, then they all learn.

In some cases, the block combination and aggregation processes illustrated in FIGS. 5-6 may be analogous to the aggregation step 308 in the federated learning workflow or the aggregation step 406 in the aggregation system 400. The blocks may represent different small language models (SLMs) or adapters, while the combined or aggregated blocks may represent the resulting larger language models or updated adapters.

The server computing device 102 may perform these combination and aggregation processes to integrate knowledge or parameters from multiple client devices 200. The resulting combined or aggregated models may incorporate diverse task-specific information while maintaining a cohesive structure.

FIG. 7 illustrates a graph showing the relationship between performance accuracy and the number of client models aggregated in a federated learning system. The graph displays a line plot with performance accuracy values on the y-axis ranging from approximately 0.340 to 0.365, and the number of client models aggregated on the x-axis ranging from 0 to 7.

The line plot in FIG. 7 demonstrates an upward trend in performance accuracy as the number of aggregated client models increases. The curve begins at a lower performance accuracy value when no models are aggregated and gradually rises as more client models are combined.

In some cases, the graph may show a steeper improvement in performance between 0 and 2 aggregated models. This initial rapid increase in accuracy may suggest that the first few aggregated models contribute significantly to the overall performance of the system.

The curve in FIG. 7 may exhibit a more gradual increase in performance accuracy between 2 and 5 aggregated models. This slower rate of improvement may indicate that additional models continue to enhance the system's performance, albeit at a diminishing rate.

Between 5 and 7 aggregated models, the curve may level off somewhat while still maintaining a slight upward trajectory. That pattern may suggest that the system approaches a point of diminishing returns, where adding more client models provides smaller incremental improvements in performance accuracy.

The trend observed in FIG. 7 may have implications for the federated learning system. In some cases, the graph may indicate that aggregating multiple client models can lead to improved overall performance accuracy. The system may benefit from combining knowledge from various client devices, potentially enhancing the robustness and generalization capabilities of the resulting model.

The graph in FIG. 7 may also suggest that there may be an optimal number of client models to aggregate for maximizing performance gains while minimizing computational overhead. In some cases, system designers may use this information to determine an efficient balance between the number of client models aggregated and the desired performance accuracy.

Federated learning, also known as collaborative learning, is an approach to machine learning (ML). Federated learning focuses on training machine learning models collaboratively across decentralized data sources. Unlike traditional centralized approaches, where data is stored in a central location, federated learning allows multiple entities (often referred to as clients) to train a model while keeping their data localized. Each client (node) trains a local model using its own dataset. Instead of exchanging raw data samples, clients share model parameters (e.g., weights and biases of a neural network) with a central server. The central server aggregates those parameters to create a global model that benefits from the collective knowledge of all clients.

Key characteristics of federated learning include data heterogeneity, privacy-preserving, and efficiency. For data heterogeneity, clients' datasets can vary significantly in terms of size, distribution, and quality. Federated learning ensures data privacy by avoiding direct data sharing. Finally, federated learning minimizes communication overhead and reduces the need for large scale data transfers.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

A number of implementations have been described. Nevertheless, it will be understood that various modifications may be made without departing from the spirit and scope of the disclosure. Accordingly, other implementations are within the scope of the following claims.

1. A method for federated fine-tuning of language models, comprising:
pruning a large language model (LLM) to create multiple small language models (SLMs) with different sparsity levels;
assigning each SLM to a client device;
fine-tuning each SLM on local data of its assigned client device;
aggregating the fine-tuned SLMs to create a global update; and
applying the global update to the SLMs and a global LLM.

2. The method of claim 1, wherein the pruning is performed using an activation-based pruning technique.

3. The method of claim 1, wherein the SLMs have different model architectures.

4. The method of claim 1, wherein the fine-tuning is performed using Low-Rank Adaptation (LoRA).

5. The method of claim 4, wherein the aggregating comprises:
creating a mask for each SLM's LoRA adapter based on its sparsity level; and
aggregating the masked adapters with the global LLM's LoRA adapter.

6. The method of claim 5, wherein applying the global update comprises:
updating the global LLM's LoRA adapter with the aggregated masked adapters; and
applying the updated global LLM's LoRA adapter to each SLM.

7. The method of claim 1, further comprising evaluating performance of the SLMs and global LLM using a benchmark dataset.

8. A system for federated fine-tuning of language models, comprising:
a server configured to prune a large language model (LLM) to create multiple small language models (SLMs) with different sparsity levels;
multiple client devices, each assigned an SLM, configured to fine-tune their assigned SLM on local data;
wherein the server is further configured to aggregate the fine-tuned SLMs to create a global update and apply the global update to the SLMs and a global LLM.

9. The system of claim 8, wherein the server is configured to perform the pruning using an activation-based pruning technique.

10. The system of claim 8, wherein the SLMs have different model architectures.

11. The system of claim 8, wherein the client devices are configured to perform the fine-tuning using Low-Rank Adaptation (LoRA).

12. The system of claim 11, wherein the server is configured to perform the aggregating by:
creating a mask for each SLM's LoRA adapter based on its sparsity level; and
aggregating the masked adapters with the global LLM's LoRA adapter.

13. The system of claim 12, wherein the server is configured to apply the global update by:
updating the global LLM's LoRA adapter with the aggregated masked adapters; and
applying the updated global LLM's LoRA adapter to each SLM.

14. The system of claim 8, wherein the server is further configured to evaluate performance of the SLMs and global LLM using a benchmark dataset.

15. A non-transitory computer-readable medium storing instructions that, when executed by a processor, cause the processor to perform operations comprising:
pruning a large language model (LLM) to create multiple small language models (SLMs) with different sparsity levels;
assigning each SLM to a client device;
fine-tuning each SLM on local data of its assigned client device;
aggregating the fine-tuned SLMs to create a global update; and
applying the global update to the SLMs and a global LLM.

16. The non-transitory computer-readable medium of claim 15, wherein the pruning is performed using an activation-based pruning technique.

17. The non-transitory computer-readable medium of claim 15, wherein the SLMs have different model architectures.

18. The non-transitory computer-readable medium of claim 15, wherein the fine-tuning is performed using Low-Rank Adaptation (LoRA).

19. The non-transitory computer-readable medium of claim 18, wherein the aggregating comprises:
creating a mask for each SLM's LoRA adapter based on its sparsity level; and
aggregating the masked adapters with the global LLM's LoRA adapter.

20. The non-transitory computer-readable medium of claim 19, wherein applying the global update comprises:
updating the global LLM's LoRA adapter with the aggregated masked adapters; and
applying the updated global LLM's LoRA adapter to each SLM.
